(19) United States
(12) Patent Application Publication
(10) Pub. No.: US 2014/0256424 A1
(43) Pub. Date: Sep. 11, 2014

(54) GAME CONTROL APPARATUS

(71) Applicant: DeNA Co., Ltd., Tokyo (JP)

(72) Inventors: Masahiro YAMADA, Tokyo (JP); Yu Ma, Tokyo (JP)

(73) Assignee: DeNA Co., Ltd., Tokyo (JP)

(21) Appl. No.: 14/140,740

(22) Filed: Dec. 26, 2013

(30) Foreign Application Priority Data
Mar. 6, 2013 (JP) 2013-044656

(51) Int. Cl. A63F 13/30

(52) U.S. Cl. CPC A63F 13/12
USPC 463/29

(57) ABSTRACT

A game control apparatus includes a making-friend-request processing unit that registers a content of a making-friend-request including at least information that identifies a player and the number of friends to make in friend matching management information, and, by periodically obtaining the contents of the making-friend-requests from the friend matching management information and selecting a pair of players among the players who made the making-friend-requests, makes the players to be friends, wherein the operation accepting unit sets an upper limitation for the number of friends to make in the ongoing making-friend-request, obtains information about the upper limitation and the number of friends to make that is currently requested, and determines the number of friends to make selectable in the making-friend-request accepting screen.

### BACKGROUND OF THE INVENTION

1. Field of the Invention

The present invention relates to a technique of controlling a game.

2. Description of the Related Art

There are games using networks, in which players can make friends by applying to other players to be friends with each other. By making friends, the players can advantageously proceed in the game by cooperating with each other when fighting against boss characters or the like and sending gifts or the like.

As described above, although mechanisms to make friends by applying to other players to be friends have been previously provided, even if a player applies to be friends with another player, if the other player does not approve, the players cannot be friends. Thus, due to a reason that the other player does not notice or ignore the application, it has been difficult for players to increase friends in the game.

Further, some players hesitate to directly apply to other players to be friends because they are afraid that the other players may reject the application. With this reason as well, it has been difficult for players to increase friends in the game.

### SUMMARY OF THE INVENTION

The present invention is made in light of the above problems, and provides a mechanism by which players can easily make friends in a network game.

According to an embodiment, there is provided a game control apparatus including an operation accepting unit that accepts an operation input from a player; a game progression control unit that progresses a game based on the operation input accepted by the operation accepting unit; and a making-friend-request processing unit that registers a content of a making-friend-request including at least information that identifies a player and the number of friends to make in friend matching management information when the operation accepting unit accepts an operation input of the making-friend-request in which the number of friends to make is designated via a making-friend-request accepting screen provided with an input box for accepting an input of the number of friends to make, and, by periodically obtaining the contents of the making-friend-requests from the friend matching management information and selecting a pair of players among the players who made the making-friend-requests, makes the players to be friends, wherein the operation accepting unit sets an upper limitation for the number of friends to make in the ongoing making-friend-request, obtains information about the upper limitation and the number of friends to make that is currently requested, and determines the number of friends to make selectable in the making-friend-request accepting screen.

Note that also arbitrary combinations of the above-described elements, and any changes of expressions in the present invention, made among methods, devices, systems, recording media, computer programs and so forth, are valid as embodiments of the present invention.

### BRIEF DESCRIPTION OF THE DRAWINGS

Other objects, features and advantages of the present invention will become more apparent from the following detailed description when read in conjunction with the accompanying drawings.

FIG. 1 is a view illustrating an example of a system structure of an embodiment;

FIG. 2 is a view illustrating an example of a hardware structure of a terminal device;

FIG. 3 is a view illustrating an example of a hardware structure of a social game control server;

FIG. 4 is a view illustrating an example of a functional structure of the terminal device and the social game control server;

FIG. 5 is a view illustrating an example of a data structure of friend matching management information;

FIG. 6 is a view illustrating an example of a data structure of player information;

FIG. 7 is a sequence diagram illustrating an example of a process of the embodiment;

FIG. 8 is a view illustrating an example of a screen;

FIG. 9 is a view illustrating another example of a screen; and

FIG. 10 is a view illustrating another example of a screen.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

### (Structure)

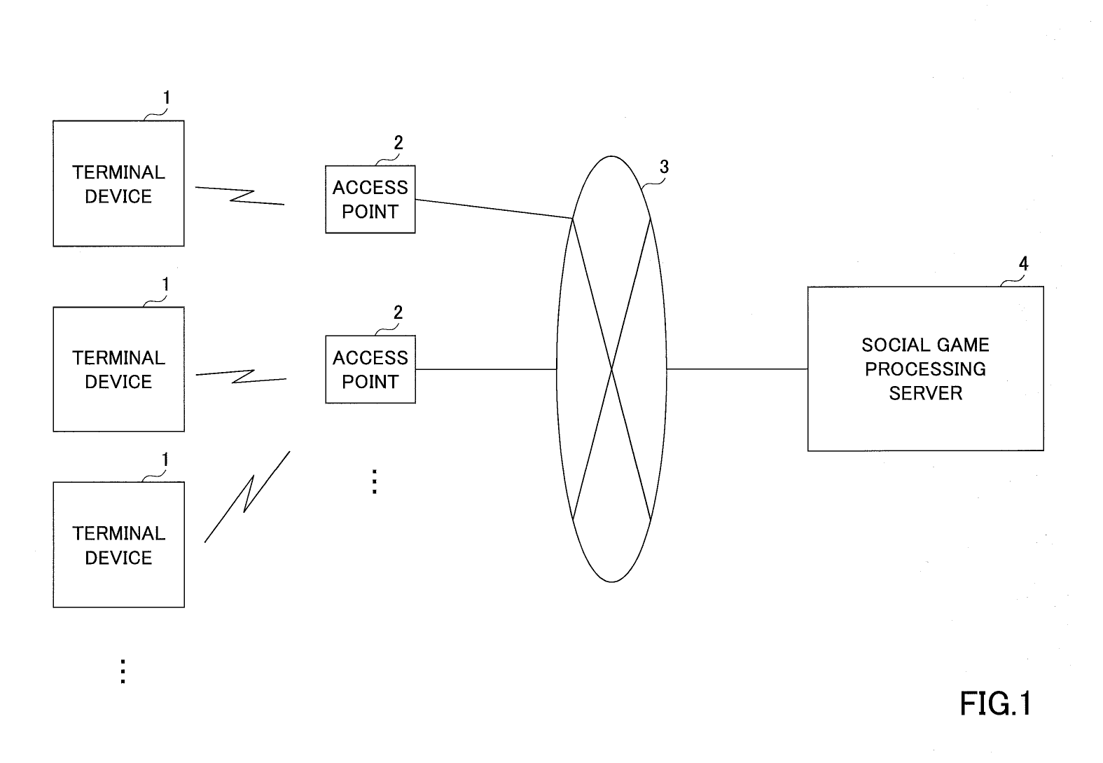

FIG. 1 is a view illustrating an example of a system structure of the embodiment.

In FIG. 1, the system includes terminal devices (player terminals) 1 possessed by players (users) such as a smartphone, a mobile phone or the like, access points 2 such as a mobile station, a Wi-Fi station or the like, a network 3 such as INTERNET or the like and a social game control server 4 that manages (controls) a game in which a plurality of players play a game via the network.

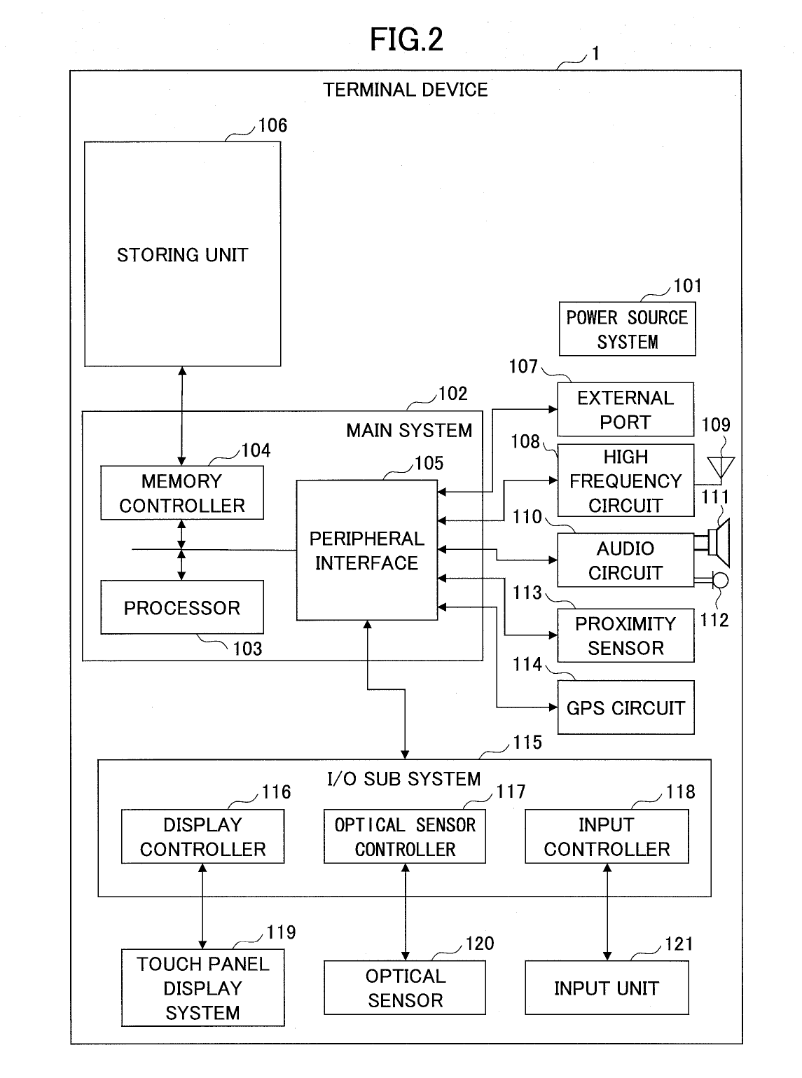

FIG. 2 is a view illustrating an example of a hardware structure of the terminal device 1.

In FIG. 2, the terminal device 1 includes a power source system 101, a main system 102 including a processor 103, a memory controller 104 and a peripheral interface 105, a storing unit 106, an external port 107, a high frequency circuit 108, an antenna 109, an audio circuit 110, a speaker 111, a microphone 112, a proximity sensor 113, a GPS (Global Positioning System) circuit 114, an I/O (Input/Output) sub system 115 including a display controller 116, an optical sensor controller 117 and an input controller 118, a touch panel display system 119, an optical sensor 120 and an input unit 121.

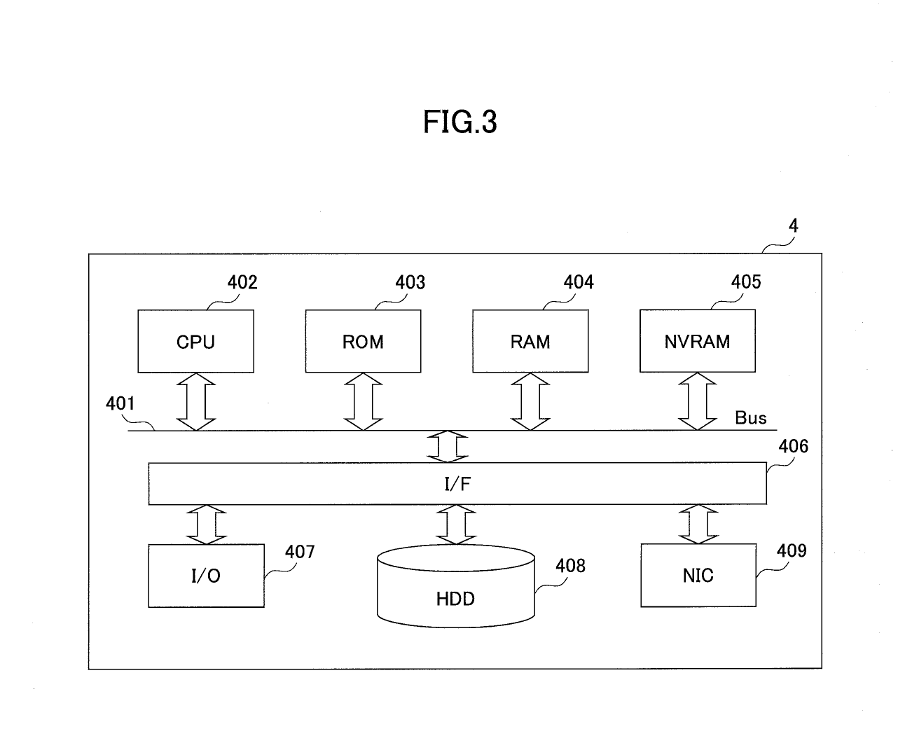

FIG. 3 is a view illustrating an example of a hardware structure of the social game control server 4.

In FIG. 3, the game management server 4 includes a CPU (Central Processing Unit) 402, a ROM (Read Only Memory) 403, a RAM (Random Access Memory) 404, an NVRAM (Non-Volatile Random Access Memory) 405 and an I/F (Interface) 406 connected to a system bus 401, an I/O (Input/Output Device) 407 for a keyboard, a mouse, a monitor, a CD/DVD (Compact Disk/Digital Versatile Disk) drive or the like, an HDD (Hard Disk Drive) 408 and an NIC (Network Interface Card) 409 connected to the I/F 406, and the like.

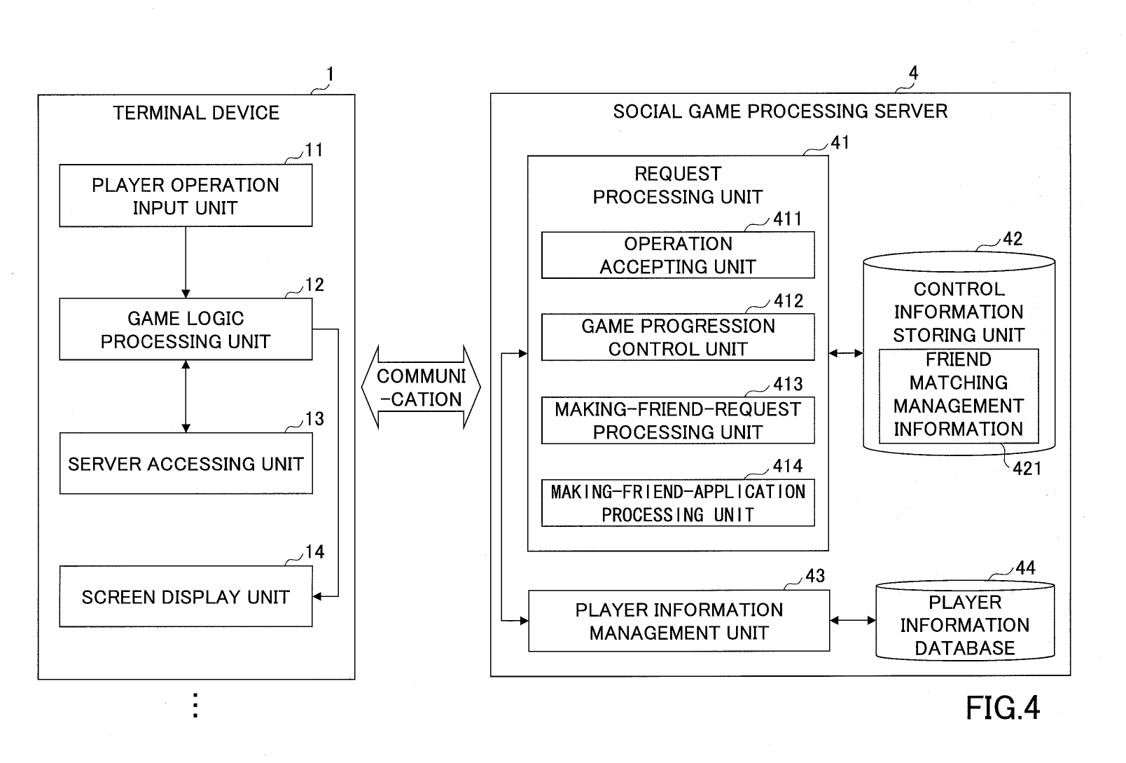

FIG. 4 is a block diagram illustrating an example of a functional structure of the terminal device 1 and the social game control server 4.

In FIG. 4, the terminal device 1 includes a player operation input unit 11, a game logic processing unit 12, a server accessing unit 13 and a screen display unit 14.

The player operation input unit 11 has a function to input (accept) an operation of a player that operates the terminal device 1.

The game logic processing unit 12 has a function to advance a game by transitioning screens in accordance with an input operation of the player input by the player operation input unit 11. There are cases for the game logic processing unit 12 in which the game logic is processed based on page data described in a Hyper Text Markup Language (HTML) or the like and scripts or the like included in the page data sent from the game control server apparatus 4 (browser type), and in which the game logic is processed based on an application which is previously downloaded and installed in the terminal device 1 (application type).

The server accessing unit 13 has a function to send a request to the social game control server 4 and receive a processed result or the like as a response from the game control server 4 when it is necessary to access the social game control server 4 in a course of the processing by the game logic processing unit 12. Here, the request includes a request of updating and a request of referring to data. The request of updating is to update player information or the like. The request of referring to data is to refer to the player information or the like.

The screen display unit 14 has a function to display screens under control of the game logic processing unit 12.

Meanwhile, the social game control server 4 includes a request processing unit 41, a control information storing unit 42, a player information management unit 43 and a player information database 44. The request processing unit 41 includes an operation accepting unit 411, a game progression control unit 412, a making-friend-request processing unit 413 and a making-friend-application processing unit 414. The control information storing unit 42 includes friend matching management information 421.

The request processing unit 41 has a function to receive a request from the terminal device 1, perform a corresponding process and send a processed result of the request to the terminal device 1 as a response. When the request processing unit 41 receives the request of updating, the request processing unit 41 performs an operation to update the player information or the like, and sends the updated player information or the like that is changed by the operation as the processed result. When the request processing unit 41 receives the request of referring to data, the request processing unit 41 refers to and obtains the corresponding player information or the like, and sends the obtained player information or the like as the processed result. Here, the response by the request processing unit 41 may include screen information which is to be operated by the player next, for the browser type.

The operation accepting unit 411 is a function unit that is mainly used for the browser type, and has a function to accept a predetermined operation input from the terminal device 1. For the application type, the game logic processing unit 12 of the terminal device 1 has a function corresponding to the operation accepting unit 411.

The game progression control unit 412 is a function unit mainly used for the browser type. The game progression control unit 412 has a function to control game progression. For the application type, the game logic processing unit 12 of the terminal device 1 has a function corresponding to the game progression control unit 412.

When a player inputs a making-friend-request with the designated number of friends to make from the terminal device 1, the making-friend-request processing unit 413 stores information of the making-friend-request as the friend matching management information 421 in the control information storing unit 42. The making-friend-request processing unit 413 has a function to match players who made the making-friend-requests at every predetermined period (an hour to two hours, for example) to make the players to be friends. Matched players are registered as friends in the player information database 44 via the player information management unit 43.

For each player, an upper limitation (five, for example) may be set for the number of friends to make in the ongoing making-friend-request(s). At this time, the player information database 44 (or the control information storing unit 42) stores an item of data indicating the upper limitation for the ongoing number of friends to make. When the upper limitation is five, if the player has not yet made a making-friend-request, the player can designate five at most in a making-friend-request. However, when the upper limitation is five and if the player has already made a making-friend-request designating “2” for the number of friends to make and no matching is made, the player can designate three at most in a new making-friend-request.

When the player is made to be friends or the making-friend-request is canceled, those numbers are subtracted from the ongoing number of friends to make. The number of friends to make that is not matched to be friends is carried over to a next matching and remain in the ongoing number of friends to make. By setting the upper limitation for the number of friends to make in the ongoing making-friend-request(s), a problem can be prevented that the making-friend-requests remain as the friend matching management information 421 for a long time due to a fact that the player is not made to be friends with the requested number of players. Further, a possibility can be also lowered that the player is disappointed due to a fact that the player is not made to be friends with the requested number of players.

When a player (first player) inputs a making-friend-application in which another player to be friends is designated by the first player from the terminal device 1, the making-friend-application processing unit 414 notifies it to the designated other player and notifies a response (approval, rejection or the like) from the other player to the first player. Matched players are registered as friends in the player information database 44 via the player information management unit 43.

The player information management unit 43 has a function to store various information (player information) of all of the players participating in the game in the player information database 44 and manage the information. The player information management unit 43 refers to or updates the player information in response to a request from the request processing unit 41.

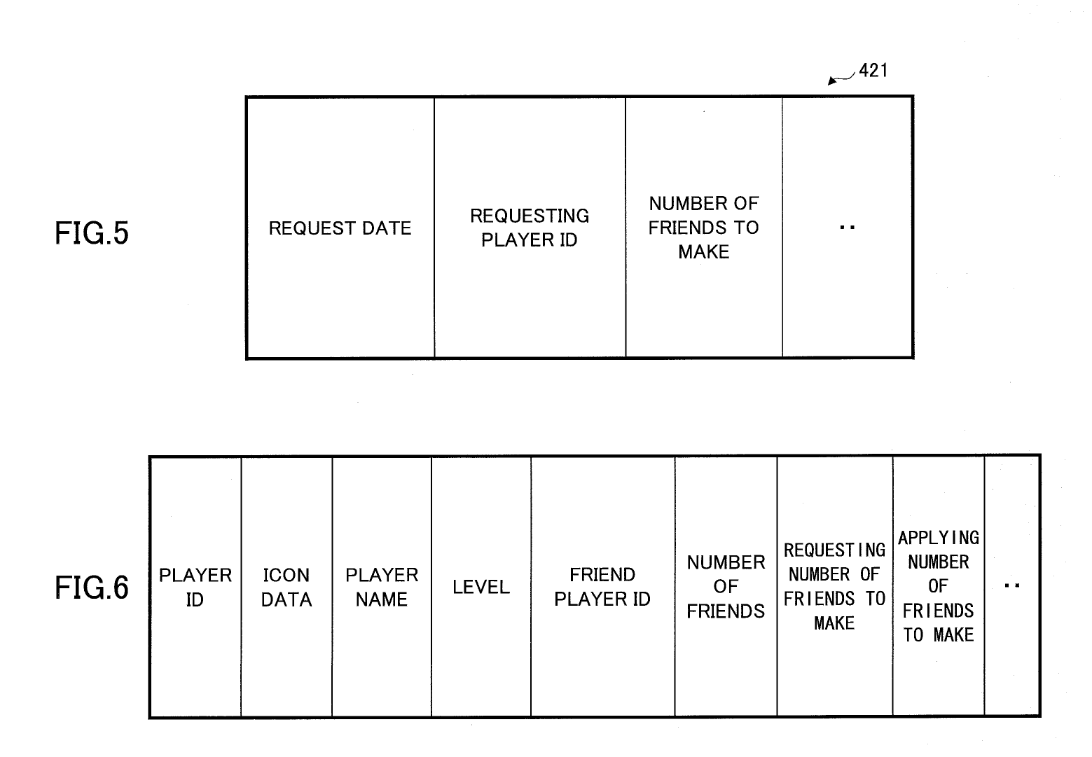

FIG. 5 is a view illustrating an example of a data structure of the friend matching management information 421 stored in the control information storing unit 42. The friend matching management information 421 includes items (fields) such as “request date”, “requesting player ID”, “number of friends to make” or the like. The “request date” is data indicating a date when the player made a making-friend-request. The “requesting player ID” is data to specify a player who made the making-friend-request. The “number of friends to make” is data indicating the number of friends to make designated in the making-friend-request.

FIG. 6 is a view illustrating an example of a data structure of the player information stored in the player information database 44. The player information includes items such as “player ID”, “icon data”, “player name”, “level”, “friend player ID”, “number of friends”, “requesting number of friends to make”, “applying number of friends to make”, or the like.

The “player ID” is data to specify (identify) the player. The “icon data” is data indicating a display icon of the player. The “player name” is data for a display name of the player. The “level” is data indicating strength of the player in the game.

The “friend player ID” is data to specify other players registered as friends of the player. The “number of friends” is data indicating the current number of friends. The “requesting number of friends to make” is data indicating the number of players to which the player is currently requesting to be friends. The “applying number of players” is data indicating the number of players to which the player is currently applying to be friends.

### (Operation)

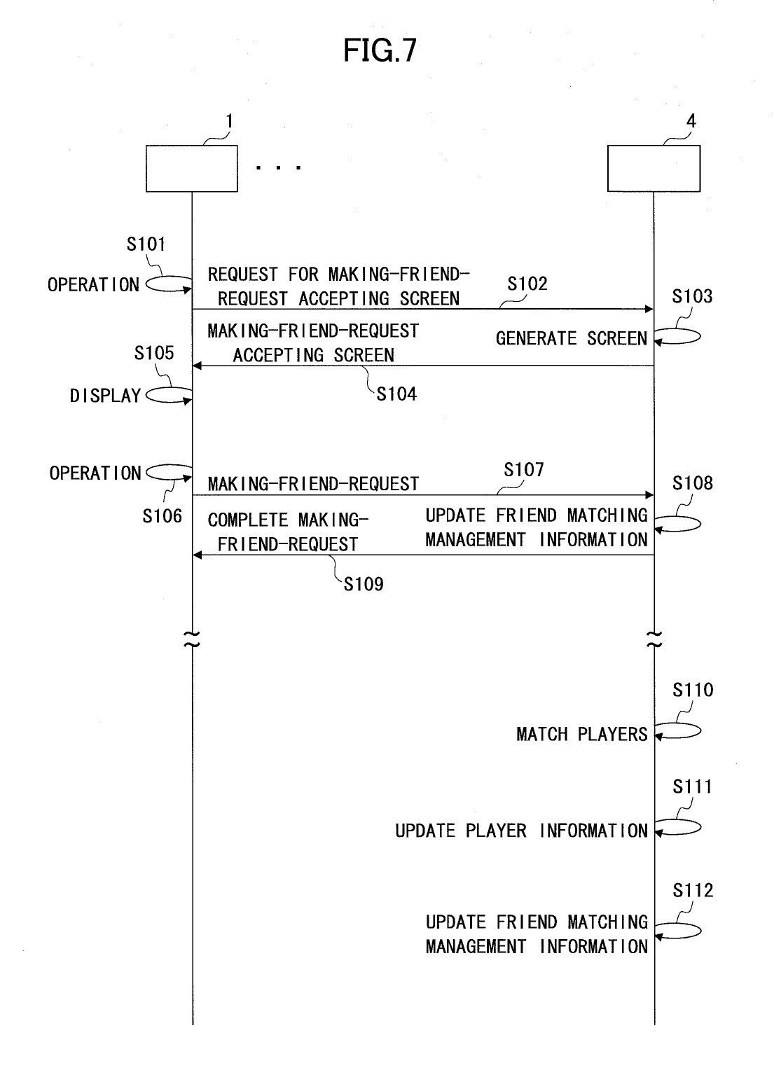

FIG. 7 is a sequence diagram illustrating an example of a process of the embodiment. It is assumed that the player who operates the terminal device 1 previously performs a log-in operation to the social game control server 4 so that the social game control server 4 can specify the player ID.

In FIG. 7, when the player inputs a request to display a making-friend-request accepting screen and the player operation input unit 11 of the terminal device 1 accepts it (step S101), the game logic processing unit 12 sends a request for the making-friend-request accepting screen to the social game control server 4 via the server accessing unit 13 (step S102).

At the social game control server 4, when the operation accepting unit 411 of the request processing unit 41 accepts the request for the making-friend-request accepting screen, the making-friend-request processing unit 413 generates the making-friend-request accepting screen (step S103), and returns it to the terminal device 1 (step S104). The screen display unit 14 of the terminal device 1 displays the making-friend-request accepting screen (step S105). Here, when there is the upper limitation for the number of friends to make in the ongoing making-friend-request(s), the making-friend-request processing unit 413 obtains information about the upper limitation and the number of friends to make that is currently requested from the player information database 44, and determines the number of friends to make selectable in the making-friend-request accepting screen. For example, when the upper limitation is five and if the player has already made a making-friend-request designating “2” for the number of friends to make and no matching is made, the number of friends to make selectable in the making-friend-request accepting screen is determined to be three.

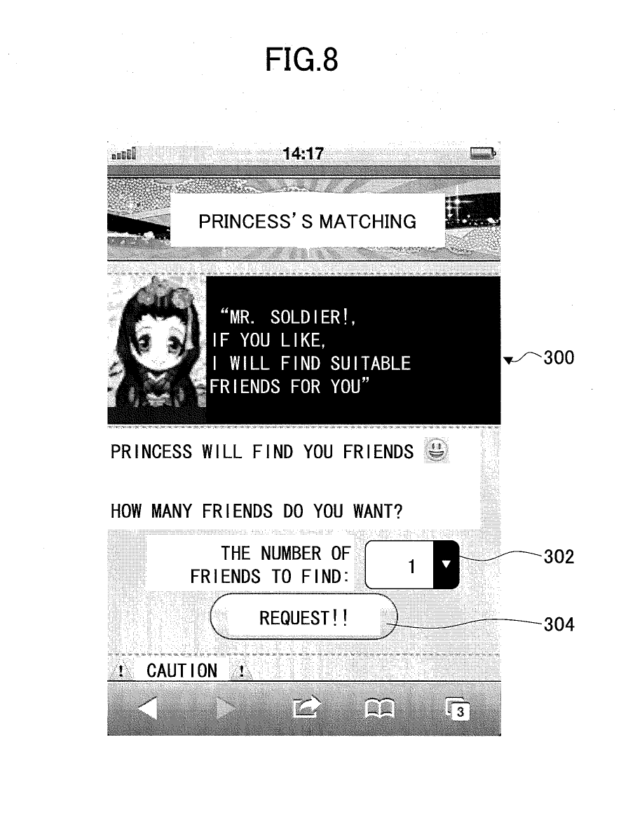

FIG. 8 is a view illustrating an example of the making-friend-request accepting screen. In this screen, a message 300 such as “Mr. soldier!, if you like, I will find suitable friends for you” from a character “princess”, an input box 302 to which the number of friends to make is input, and a “request” button 304 are displayed.

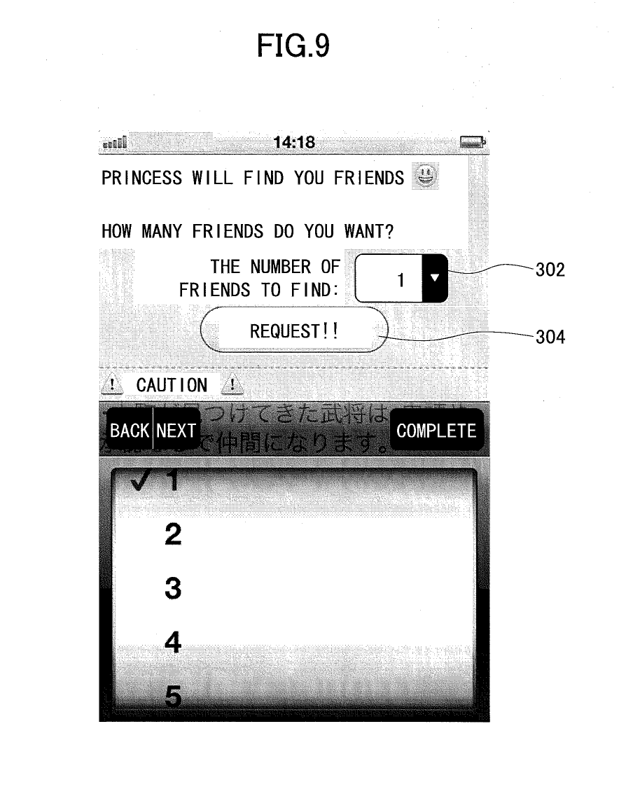

FIG. 9 is a view illustrating an example of a screen that is displayed when the player selects the input box to which the number of friends to make is input in the making-friend-request accepting screen in FIG. 8. In this screen, when assuming that the upper limitation for the number of friends to make in the ongoing making-friend-request(s) is five, the selectable number is five as well. As described above, if the player has already made another making-friend-request and that is not matched yet, the selectable number less than five is displayed.

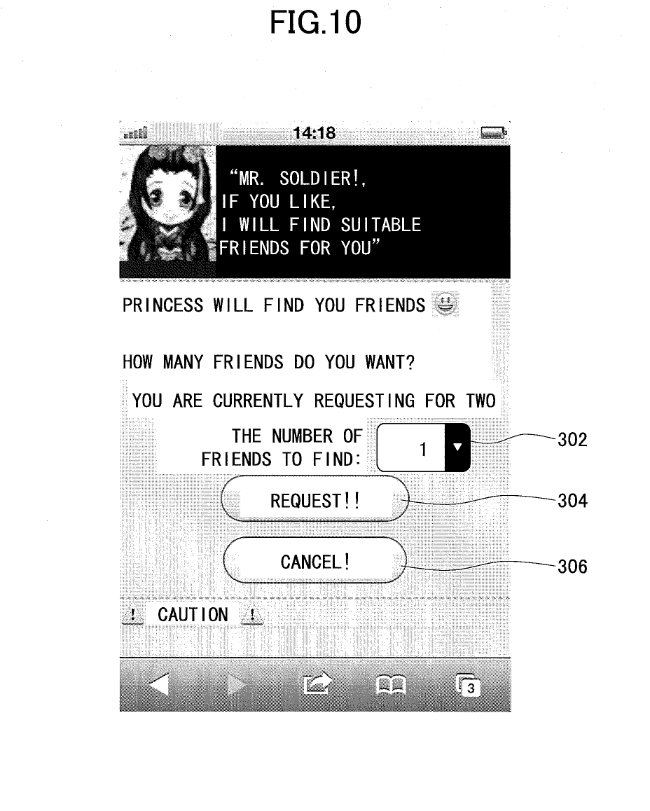

FIG. 10 is a view illustrating an example of a screen that is displayed when the player completes inputting the number of friends to make in the input box 302 in FIG. 9. In this screen, the number of friends to make, and a “cancel” button 306 for canceling the making-friend-request are displayed. When the player selects the “cancel” button 306, all of the making-friend-requests for the player may be canceled.

Referring back to FIG. 7, when the player inputs the making-friend-request and the number of friends to make and the player operation input unit 11 of the terminal device 1 accepts it (step S106), the game logic processing unit 12 sends the making-friend-request and the number of friends to make to the social game control server 4 via the server accessing unit 13 (step S107).

At the social game control server 4, when the operation accepting unit 411 of the request processing unit 41 accepts the making-friend-request and the number of friends to make, the making-friend-request processing unit 413 registers the requested date, the player ID and the number of friends to make as the friend matching management information 421 in the control information storing unit 42 (step S108). When the control information storing unit 42 is updated, the making-friend-request processing unit 413 sends a completion of accepting the making-friend-request to the terminal device 1 (step S109).

Thereafter, at the social game control server 4, the making-friend-request processing unit 413 of the request processing unit 41 periodically matches the players based on the making-friend-requests stored as the friend matching management information 421 in the control information storing unit 42 and makes friends within a possible range (step S110).

For example, the making-friend-request processing unit 413 matches players who made the making-friend-requests by sorting them by their levels and preferentially making friends with each other from the players at higher levels. Further, at this time, possibly, the making-friend-request processing unit 413 makes the players at the same level to be friends, and if it is impossible, the making-friend-request processing unit 413 makes the players at near levels to be friends. Further, among players at the same condition such as at the same level or the like, the making-friend-request processing unit 413 refers to the requested date of the friend matching management information 421 and preferentially matches players whose requested date are earlier.

Next, the making-friend-request processing unit 413 updates the friend player ID and the requesting number of friends to make of the respective player of the player information in the player information database 44 (FIG. 6) based on the matching result via the player information management unit 43 (step S111).

Next, when all of the number of friends to make for the player is matched, the making-friend-request processing unit 413 deletes the making-friend-request of the player from the friend matching management information 421 in the control information storing unit 42. Alternatively, the making-friend-request processing unit 413 may add a flag indicating that the request is completed, without deleting the making-friend-request. When not all of the number of friends to make for the player is matched, the making-friend-request processing unit 413 subtracts the number of players who are matched with the player from the number of friends to make from the friend matching management information 421 in the control information storing unit 42 and updates the number of friends to make (step S112).

For the players who are logging-in the social game control server 4 and playing the game, a notice that a friend(s) is made based on the making-friend-request is sent. For the players who are not logging-in the social game control server 4 at that time, a notice that the friend(s) is made based on the making-friend-request is sent when the player logs-in the social game control server 4.

Further, when the player makes the making-friend-application processed by the making-friend-application processing unit 414 at the same time with the making-friend-request, and if a total of the requesting number of friends to make and the applying number of friends to make exceeds a predetermined number (100, for example), the making-friend-request is automatically canceled.

As explained above, according to the embodiment, a mechanism capable of easily increasing friends in a network game can be provided. In other words, as making-friend-requests from players are collected and friends are made by a system side, players can make friends at a high possibility without spending a long time. Further, as the system determines who are to be friends, psychological barriers for players are low when requesting other players to be friends and the players can easily make friends.

Constituents of the terminal device 1 and the game control server apparatus 4 in FIG. 4 indicate not a structure of hardware units but blocks of functional units. The individual constituents of the terminal device 1 and the game control server apparatus 4 may be embodied by arbitrary combinations of hardware and software, typified by a CPU of an arbitrary computer, a memory, a program loaded in the memory so as to embody the constituents illustrated in the drawings, a storage unit for storing the program such as a hard disk, and an interface for network connection. It may be understood by those skilled in the art that methods and devices for the embodiment allow various modifications. Further, functions performed by the game control server apparatus 4 may be unnecessarily actualized in a single apparatus and may be distributed in a plurality of apparatuses.

The embodiments include the following features as well.

(1) A game control apparatus including:

an operation accepting unit that accepts an operation input from a player;

a game progression control unit that progresses a game based on the operation input accepted by the operation accepting unit; and

a making-friend-request processing unit that registers a content of a making-friend-request in friend matching management information when the operation accepting unit accepts an operation input of the making-friend-request and, by periodically obtaining the contents of the making-friend-requests from the friend matching management information and matching players, makes the players to be friends.

(2) In the above game control apparatus, the making-friend-request may be made by designating the number of friends to make.

(3) In the above game control apparatus, the making-friend-request may be made such that the designated number of friends to make is set within a predetermined maximum number.

(4) In the above game control apparatus, wherein the maximum number for the number of friends to make selectable in a next making-friend-request may be obtained by subtracting the number of friends to make designated in the current making-friend-request from the maximum number for the number of friends to make selectable in the current making-friend-request, and the maximum number for the number of friends to make selectable in the next making-friend-request may increase when the making-friend-request is canceled or the player is made to be friends.

(5) In the above game control apparatus, the making-friend-request processing unit may carry over the making-friend-request in which the players are not matched to be friends to a next process.

(6) In the above game control apparatus, the making-friend-request processing unit may sort the players who made the making-friend-requests in the order of descending levels, and preferentially make the players at higher levels to be friends.

(7) A non-transitory computer-readable recording medium having recorded thereon a program for a game control apparatus to execute functions including:

an operation accepting function that accepts an operation input from a player;

a game progression control function that progresses a game based on the operation input accepted by the operation accepting function; and

a making-friend-request processing function that registers a content of a making-friend-request in friend matching management information when the operation accepting function accepts an operation input of the making-friend-request and, by periodically obtaining the contents of the making-friend-requests from the friend matching management information and matching players, makes the players to be friends.

Although a preferred embodiment of the game control server apparatus has been specifically illustrated and described, it is to be understood that minor modifications may be made therein without departing from the spirit and scope of the invention as defined by the claims.

The present application is based on and claims the benefit of priority of Japanese Priority Application No. 2013-044656 filed on Mar. 6, 2013, the entire contents of which are hereby incorporated by reference.

1. A game control apparatus comprising:
an operation accepting unit that accepts an operation input of a making-friend-request from a player, the making-friend-request including at least ID information that identifies the player and a number of friends to make;
a game progression control unit that progresses a game based on the operation input accepted by the operation accepting unit; and
a making-friend-request processing unit that
registers the making-friend-request in an information storing unit when the operation accepting unit accepts the operation input of the making-friend-request,
periodically obtains the making-friend-requests from the information storing unit, and
selects a pair of players among the players identified by the ID information of the obtained making-friend-requests to make the selected players to be friends,
wherein the operation accepting unit obtains a basic upper limitation number of friends to make for which each player is capable of requesting at the same time and a number of friends to make that is currently requested by the player,
determines an upper limitation number of friends to make selectable by the user by subtracting the number of friends to make that is currently requested by the player from the basic upper limitation number of friends to make, and
accepts the operation input of the making-friend-request from the user via a making-friend-request accepting screen, the making-friend-request accepting screen being provided with an input box for accepting the number of friends to make selected by the player, the input box being configured such that the user is capable of selecting the number of friends to make within the determined upper limitation number of friends to make for the user.

2. The game control apparatus according to claim 1,
wherein the upper limitation number of friends to make selectable in a subsequent making-friend-request is obtained by subtracting the number of friends to make designated in a present making-friend-request from the upper limitation number of friends to make selectable in a present making-friend-request, and
wherein the upper limitation the number of friends to make selectable in the subsequent making-friend-request increases when the making-friend-request is canceled or the player is made to be friends.

3. The game control apparatus according to claim 1,
wherein the making-friend-request processing unit carries over the making-friend-request in which players are not matched to be friends to a subsequent process.

4. The game control apparatus according to claim 1,
wherein the making-friend-request processing unit, by obtaining levels of the players who made the making-friend-requests from player information stored in a player information database, sorting the players in the order of descending levels, and selecting the pair of players among the players at higher levels, makes the pair of the players at higher levels to be friends.

5. A non-transitory computer-readable recording medium having recorded thereon a program for a game control apparatus to execute functions comprising:
an operation accepting function that accepts an operation input of a making-friend-request from a player, the making-friend-request including at least ID information that identifies the player and a number of friends to make;
a game progression control function that progresses a game based on the operation input accepted by the operation accepting function; and
a making-friend-request processing function that
registers the making-friend-request in an information storing unit when the operation accepting function accepts the operation input of the making-friend-request,
periodically obtains the making-friend-requests from the information storing unit and
selects a pair of players among the players identified by the ID information of the obtained making-friend-requests to make the selected players to be friends,
wherein the operation accepting function obtains a basic upper limitation number of friends to make for which each player is capable of requesting at the same time and a number of friends to make that is currently requested by the player,
determines an upper limitation number of friends to make selectable by the user by subtracting the number of friends to make that is currently requested by the player from the basic upper limitation number of friends to make, and
accepts the operation input of the making-friend-request from the user via a making-friend-request accepting screen, the making-friend-request accepting screen being provided with an input box for accepting the number of friends to make selected by the player, the input box being configured such that the user is capable of selecting the number of friends to make within the determined upper limitation number of friends to make for the user.
